(19) United States
(12) Patent Application Publication
(10) Pub. No.: US 2024/0413945 A1
(43) Pub. Date: Dec. 12, 2024

(54) ADAPTIVE DE-MODULATION REFERENCE SIGNAL PATTERN DESIGN

(71) Applicant: Nokia Technologies Oy, Espoo (FI)

(72) Inventors: Mohamad SAYED HASSAN, Massy (FR); Xiaomao MAO, Massy (FR); Luca ROSE, Massy (FR)

(21) Appl. No.: 18/702,458

(22) PCT Filed: Oct. 20, 2021
(86) PCT No.: PCT/EP2021/079080

§ 371 Date: Apr. 18, 2024

(51) Int. Cl. H04L 5/00

(52) U.S. Cl. CPC H04L 5/0048; H04L 5/0058

(57) ABSTRACT

There are provided measures for adaptive de-modulation reference signal pattern design. Such measures exemplarily comprise receiving, from a communication entity, in a physical channel, at least one reference signal representative of radio conditions in at least one portion of said physical channel, and predicting, based on said at least one reference signal and a model of said physical channel, a first channel estimation representative of radio conditions in a total of said physical channel.

### FIELD

Various example embodiments relate to adaptive de-modulation reference signal pattern design. More specifically, various example embodiments exemplarily relate to measures (including methods, apparatuses and computer program products) for realizing adaptive de-modulation reference signal pattern design.

### BACKGROUND

The present specification generally relates to uplink (UL) enhancement. More specifically, the present specification relates to reference signal overhead in uplink transmission. In 3^{rd} Generation Partnership Project (3GPP) Release 17, de-modulation reference signal (DMRS) enhancements and optimization have been addressed in different work items.

From one side, having more DMRS pilots leads to better channel estimation. On the other hand, more pilots increase the UL overhead. Different DMRS patterns have been discussed from 3GPP Release 15 to 3GPP Release 17. All the DMRS patterns proposed consider deterministic pattern design. The main drawback of deterministic approaches is the lack of elasticity, and the inability to adapt to channel variations, which can lead to UL overhead (higher DMRS density) or bad performance (lower DMRS density).

The DMRS pattern, the number of DMRS, and the position of DMRS pilots are configured by radio resource control (RRC). Thus, to reconfigure those parameters, RRC reconfiguration is needed.

The user equipment (UE) radio conditions may change and may thus require more or less DMRS pilots.

RRC reconfiguration, however, is a heavy and slow method to adapt with channel variation.

A main drawback of DMRS patterns specified in 3GPP Release 15 is the deterministic approach used to define these patterns. Thus, the DMRS pattern cannot track the channel conditions and it can lead to an unnecessary overhead.

To optimize DMRS allocation, configuring the physical uplink shared channel (PUSCH) without DMRS or less DMRS in some PUSCHs within an inter-slot bundle was proposed.

FIG. 7 shows a schematic diagram of an example of a DMRS pattern in the time domain, and in particular illustrates DMRS location/granularity in the time domain under the assumption of joint channel estimation. More specifically, FIG. 7 shows an example of a proposed DMRS pattern for a scenario where phase continuity over UL slots can be guaranteed.

It was further proposed that a transmitter sends different time-domain DMRS patterns. A receiver may receive an indication that a plurality of time-domain resources are associated for purposes of DMRS bundling of a physical channel. Based thereon, the receiver may determine a first DMRS pattern for a first subset of time-domain resources of the plurality of time-domain resources, and a second DMRS pattern for a second subset of time-domain resources of the plurality of time-domain resources, wherein the first DMRS pattern and the second DMRS pattern are different DMRS patterns. This approach requires to define multiple DMRS patterns, to signal multiple DMRS patterns, and it is applicable only where DMRS bundling is assumed at the receiver side.

Still further, pilot-less (no DMRS) transmission was proposed using machine learning. However, a pilot-less approach requires a fundamental change in the standard. In addition, a pilot-less approach requires the system to be trained for different scenarios, as the channel is derived from data symbols. Pilot-less transmission does not involve any DMRS pattern related optimization.

Hence, the problem arises that either unnecessary overhead is caused when applying DMRS or the performance of channel estimation is substantially reduced in particular under changing radio conditions of communication endpoints such as mobile terminals.

Hence, there is a need to provide for adaptive de-modulation reference signal pattern design.

### SUMMARY

Various example embodiments aim at addressing at least part of the above issues and/or problems and drawbacks.

Various aspects of example embodiments are set out in the appended claims.

According to an exemplary aspect, there is provided a method comprising receiving, from a communication entity, in a physical channel, at least one reference signal representative of radio conditions in at least one portion of said physical channel, and predicting, based on said at least one reference signal and a model of said physical channel, a first channel estimation representative of radio conditions in a total of said physical channel.

According to an exemplary aspect, there is provided a method comprising receiving a configuration of a number of reference signals to be sent, the reference signals corresponding to a plurality of reference signals representative of radio conditions in a total of a physical channel based on said configuration, receiving an instruction for a reduction of said reference signals to be sent, setting a transmission scheme of at least one reference signal representative of radio conditions in at least one portion of said physical channel based on said configuration and said instruction, and transmitting, in said physical channel, said at least one reference signal representative of radio conditions in said at least one portion of said physical channel according to said transmission scheme.

According to an exemplary aspect, there is provided an apparatus comprising receiving circuitry configured to receive, from a communication entity, in a physical channel, at least one reference signal representative of radio conditions in at least one portion of said physical channel, and predicting circuitry configured to predict, based on said at least one reference signal and a model of said physical channel, a first channel estimation representative of radio conditions in a total of said physical channel.

According to an exemplary aspect, there is provided an apparatus comprising receiving circuitry configured to receive a configuration of a number of reference signals to be sent, the reference signals corresponding to a plurality of reference signals representative of radio conditions in a total of a physical channel based on said configuration, and to receive an instruction for a reduction of said reference signals to be sent, setting circuitry configured to set a transmission scheme of at least one reference signal representative of radio conditions in at least one portion of said physical channel based on said configuration and said instruction, and transmitting circuitry configured to transmit, in said physical channel, said at least one reference signal representative of radio conditions in said at least one portion of said physical channel according to said transmission scheme.

According to an exemplary aspect, there is provided an apparatus comprising at least one processor, at least one memory including computer program code, and at least one interface configured for communication with at least another apparatus, the at least one processor, with the at least one memory and the computer program code, being configured to cause the apparatus to perform receiving, from a communication entity, in a physical channel, at least one reference signal representative of radio conditions in at least one portion of said physical channel, and predicting, based on said at least one reference signal and a model of said physical channel, a first channel estimation representative of radio conditions in a total of said physical channel.

According to an exemplary aspect, there is provided an apparatus comprising at least one processor, at least one memory including computer program code, and at least one interface configured for communication with at least another apparatus, the at least one processor, with the at least one memory and the computer program code, being configured to cause the apparatus to perform receiving a configuration of a number of reference signals to be sent, the reference signals corresponding to a plurality of reference signals representative of radio conditions in a total of a physical channel based on said configuration, receiving an instruction for a reduction of said reference signals to be sent, setting a transmission scheme of at least one reference signal representative of radio conditions in at least one portion of said physical channel based on said configuration and said instruction, and transmitting, in said physical channel, said at least one reference signal representative of radio conditions in said at least one portion of said physical channel according to said transmission scheme.

According to an exemplary aspect, there is provided a computer program product comprising computer-executable computer program code which, when the program is run on a computer (e.g. a computer of an apparatus according to any one of the aforementioned apparatus-related exemplary aspects of the present disclosure), is configured to cause the computer to carry out the method according to any one of the aforementioned method-related exemplary aspects of the present disclosure.

Such computer program product may comprise (or be embodied) a (tangible) computer-readable (storage) medium or the like on which the computer-executable computer program code is stored, and/or the program may be directly loadable into an internal memory of the computer or a processor thereof.

Any one of the above aspects enables an efficient reduction of UL DMRS overhead, flexible of DMRS pattern modification/change, as well as an UL performance improvement, to thereby solve at least part of the problems and drawbacks identified in relation to the prior art.

By way of example embodiments, there is provided adaptive de-modulation reference signal pattern design. More specifically, by way of example embodiments, there are provided measures and mechanisms for realizing adaptive de-modulation reference signal pattern design.

Thus, improvement is achieved by methods, apparatuses and computer program products enabling/realizing adaptive de-modulation reference signal pattern design.

### BRIEF DESCRIPTION OF THE DRAWINGS

In the following, the present disclosure will be described in greater detail by way of non-limiting examples with reference to the accompanying drawings, in which

FIG. 1 is a block diagram illustrating an apparatus according to example embodiments,

FIG. 2 is a block diagram illustrating an apparatus according to example embodiments,

FIG. 3 is a block diagram illustrating an apparatus according to example embodiments,

FIG. 4 is a block diagram illustrating an apparatus according to example embodiments,

FIG. 5 is a schematic diagram of a procedure according to example embodiments,

FIG. 6 is a schematic diagram of a procedure according to example embodiments,

FIG. 7 shows a schematic diagram of an example of a de-modulation reference signal pattern in the time domain,

FIG. 8 shows a schematic diagram illustrating channel estimation interpolation according to example embodiments,

FIG. 9 is a schematic diagram of a procedure according to example embodiments,

FIG. 10 shows a schematic diagram illustrating de-modulation reference signal pattern options in the frequency domain according to example embodiments,

FIG. 11 is a schematic diagram of a procedure according to example embodiments,

FIG. 12 shows a schematic diagram illustrating a comparison of de-modulation reference signal pattern selections in the frequency domain according to example embodiments, and

FIG. 13 is a block diagram alternatively illustrating apparatuses according to example embodiments.

### DETAILED DESCRIPTION

The present disclosure is described herein with reference to particular non-limiting examples and to what are presently considered to be conceivable embodiments. A person skilled in the art will appreciate that the disclosure is by no means limited to these examples, and may be more broadly applied.

It is to be noted that the following description of the present disclosure and its embodiments mainly refers to specifications being used as non-limiting examples for certain exemplary network configurations and deployments. Namely, the present disclosure and its embodiments are mainly described in relation to 3GPP specifications being used as non-limiting examples for certain exemplary network configurations and deployments. As such, the description of example embodiments given herein specifically refers to terminology which is directly related thereto. Such terminology is only used in the context of the presented non-limiting examples, and does naturally not limit the disclosure in any way. Rather, any other communication or communication related system deployment, etc. may also be utilized as long as compliant with the features described herein.

Hereinafter, various embodiments and implementations of the present disclosure and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

According to example embodiments, in general terms, there are provided measures and mechanisms for (enabling/realizing) adaptive de-modulation reference signal pattern design.

In brief, according to example embodiments, the DMRS pattern is optimized in the frequency domain and in the time domain. Heretofore, a dynamic and flexible DMRS pattern target is provided to reduce the UL overhead due to high density of DMRS pilots. This allows a reduced UL DMRS overhead and a flexibility of pattern modification/change.

In particular, according to example embodiments, a predictor function (which can be implemented by a recursive neural network (RNN)) for prediction of an optimal future DMRS pattern and the channel estimates is used.

More specifically, a DMRS pattern prediction including time domain and frequency domain DMRS allocation, a channel estimate model that helps in addition to a minimum number of UL DMRS resource elements (RE) to estimate the channel without performance degradation, and a signaling procedure to indicate to a UE the DMRS pattern that should be used in a future UL transmission are provided according to example embodiments.

Example embodiments are specified below in more detail.

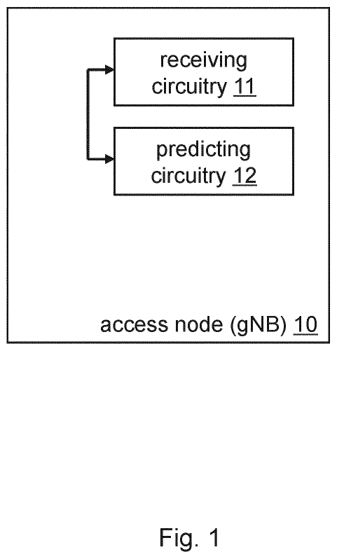

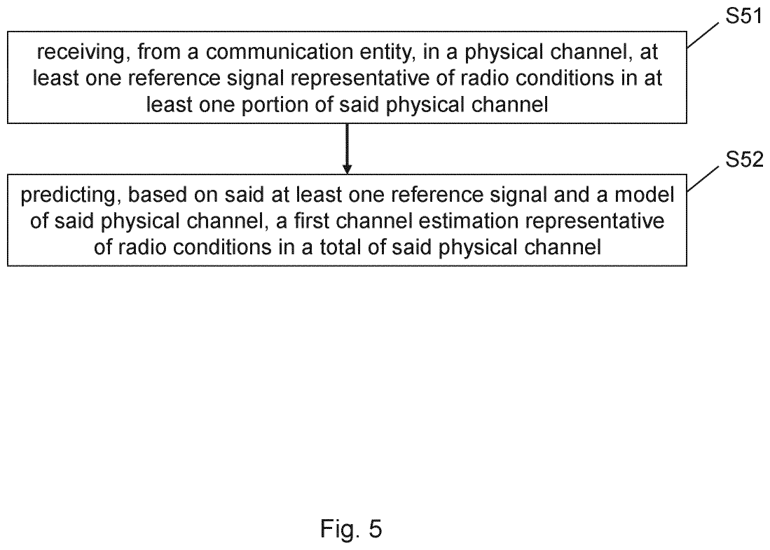

FIG. 1 is a block diagram illustrating an apparatus according to example embodiments. The apparatus may be an access node 10 such as a base station comprising a receiving circuitry 11 and a predicting circuitry 12. The receiving circuitry 11 receives, from a communication entity, in a physical channel, at least one reference signal representative of radio conditions in at least one portion of said physical channel. The predicting circuitry 12 predicts, based on said at least one reference signal and a model of said physical channel, a first channel estimation representative of radio conditions in a total of said physical channel. FIG. 5 is a schematic diagram of a procedure according to example embodiments. The apparatus according to FIG. 1 may perform the method of FIG. 5 but is not limited to this method. The method of FIG. 5 may be performed by the apparatus of FIG. 1 but is not limited to being performed by this apparatus.

As shown in FIG. 5, a procedure according to example embodiments comprises an operation of receiving (S51), from a communication entity, in a physical channel, at least one reference signal representative of radio conditions in at least one portion of said physical channel, and an operation of predicting (S52), based on said at least one reference signal and a model of said physical channel, a first channel estimation representative of radio conditions in a total of said physical channel.

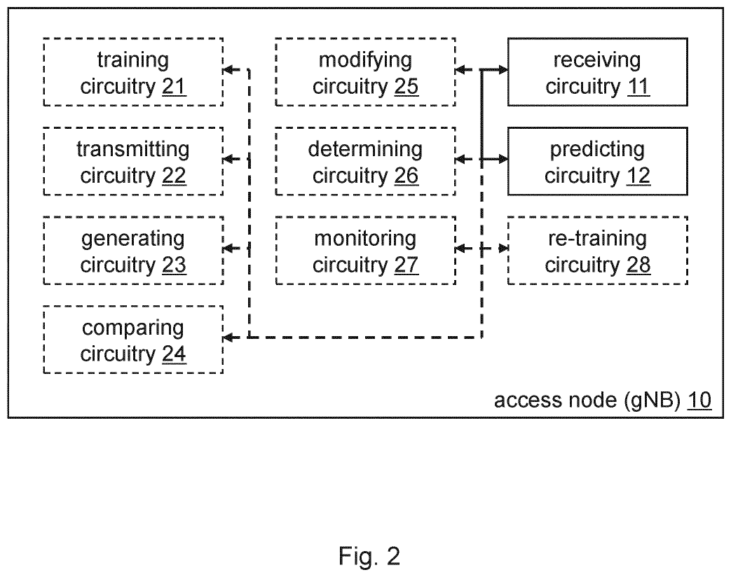

FIG. 2 is a block diagram illustrating an apparatus according to example embodiments. In particular, FIG. 2 illustrates a variation of the apparatus shown in FIG. 1. The apparatus according to FIG. 2 may thus further comprise a training circuitry 21, a transmitting circuitry 22, a generating circuitry 23, a comparing circuitry 24, a modifying circuitry 25, a determining circuitry 26, a monitoring circuitry 27, and/or a re-training circuitry 28.

In an embodiment at least some of the functionalities of the apparatus shown in FIG. 1 (or 2) may be shared between two physically separate devices forming one operational entity. Therefore, the apparatus may be seen to depict the operational entity comprising one or more physically separate devices for executing at least some of the described processes.

According to a variation of the procedure shown in FIG. 5, exemplary additional operations are given, which are inherently independent from each other as such. According to such variation, an exemplary method according to example embodiments may comprise an operation of training said model of said physical channel, and an operation of transmitting, in response to completion of said training of said model of said physical channel, towards said communication entity, an instruction for a reduction of reference signals to be sent by said communication entity.

According to a variation of the procedure shown in FIG. 5, exemplary details of the training operation are given, which are inherently independent from each other as such. Such exemplary training operation according to example embodiments may comprise an operation of receiving a plurality of reference signals representative of radio conditions in said total of said physical channel, including said at least one reference signal, an operation of generating, based on said plurality of reference signals, a second channel estimation representative of radio conditions in said total of said physical channel, an operation of comparing said first channel estimation with said second channel estimation, and an operation of modifying said model of said physical channel based on a result of said comparing.

According to further example embodiments, said plurality of reference signals is arranged in a time domain, and said instruction includes a value as a reduction parameter based on which an originally configured number of reference signals to be sent by said communication entity is to be reduced.

According to further example embodiments, said reduction parameter is a subtrahend to be subtracted from said originally configured number of reference signals to be sent by said communication entity.

According to a variation of the procedure shown in FIG. 5, exemplary additional operations are given, which are inherently independent from each other as such. According to such variation, an exemplary method according to example embodiments may comprise an operation of determining completion of said training of said model of said physical channel, if a deviation between said first channel estimation and said second channel estimation is smaller than a predetermined training threshold.

According to further example embodiments, said originally configured number relates to one slot.

Alternatively, according to further example embodiments, said originally configured number relates to a predetermined number of slots.

According to further example embodiments, said predetermined number of slots include a plurality of consecutive slots. Alternatively, according to further example embodiments, said predetermined number of slots include a plurality of non-consecutive slots.

According to further example embodiments, a plurality of reference signal resources corresponding to said plurality of reference signals is arranged in a frequency domain, and said instruction includes at least one value as at least one reduction parameter based on which an originally configured number of reference signals to be sent by said communication entity is to be reduced.

According to further example embodiments, said at least one reduction parameter is at least one reduction divisor by which said originally configured number of reference signals to be sent by said communication entity is to be divided.

According to a variation of the procedure shown in FIG. 5, exemplary additional operations are given, which are inherently independent from each other as such. According to such variation, an exemplary method according to example embodiments may comprise an operation of determining said at least one value as a sub-set of candidate values corresponding to said originally configured number of reference signals to be sent by said communication entity for which, when only reference signals of said plurality of reference signals corresponding to said respective candidate value are considered in said predicting, a deviation between said first channel estimation and said second channel estimation is smaller than a predetermined training threshold. Here, in relation to said training of a respective model of said physical channel corresponding to a respective one of said at least one value, only reference signals of said plurality of reference signals corresponding to said respective candidate value are considered in said predicting.

According to further example embodiments, said originally configured number relates to one physical resource block. Alternatively, according to further example embodiments, said originally configured number relates to a predetermined number of physical resource blocks.

According to further example embodiments, said plurality of reference signals is arranged in a time domain, and said instruction includes a first value as a first reduction parameter based on which an originally configured number of reference signals to be sent by said communication entity in said time domain is to be reduced, and of at least one of said plurality of reference signals, a plurality of reference signal resources corresponding to respective components of said respective reference signal is arranged in a frequency domain, and said instruction includes at least one second value as at least one second reduction parameter based on which an originally configured number of reference signal components to be sent by said communication entity on said plurality of reference signal resources in said frequency domain is to be reduced.

According to a variation of the procedure shown in FIG. 5, exemplary additional operations are given, which are inherently independent from each other as such. According to such variation, an exemplary method according to example embodiments may comprise an operation of monitoring a performance value in relation to payload transmission from said communication entity via said a physical channel, and an operation of transmitting, if said performance value is smaller than a predetermined performance threshold, towards said communication entity, an instruction to return to an originally configured number of reference signals to be sent by said communication entity.

According to a variation of the procedure shown in FIG. 5, exemplary additional operations are given, which are inherently independent from each other as such. According to such variation, an exemplary method according to example embodiments may comprise an operation of re-training, if said performance value is smaller than said predetermined performance threshold, said model of said physical channel.

According to further example embodiments, said performance value is an error rate.

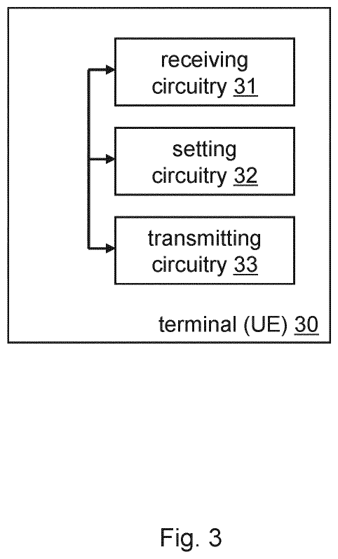

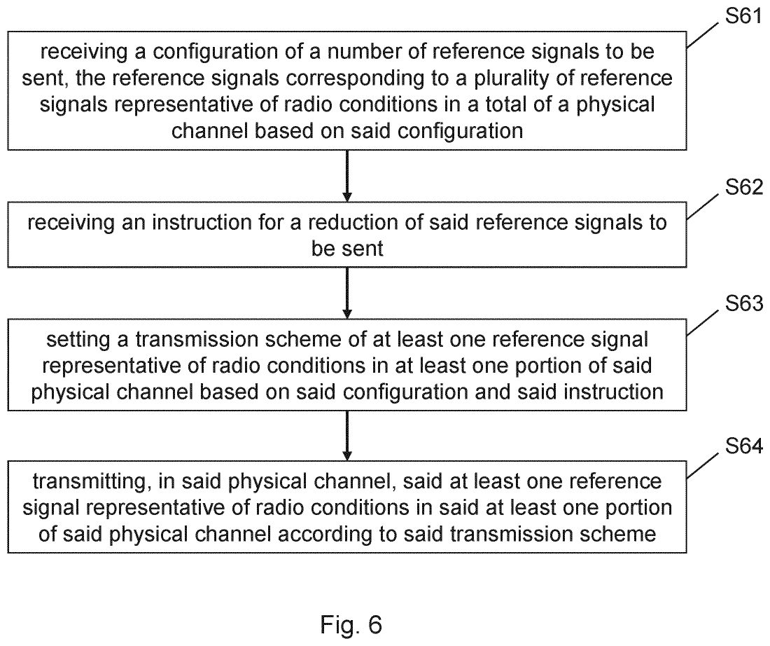

FIG. 3 is a block diagram illustrating an apparatus according to example embodiments. The apparatus may be a terminal 30 such as a user equipment comprising a receiving circuitry 31, a setting circuitry 32, and a transmitting circuitry 33. The receiving circuitry 31 receives a configuration of a number of reference signals to be sent, the reference signals corresponding to a plurality of reference signals representative of radio conditions in a total of a physical channel based on said configuration. The receiving circuitry 31 further receives an instruction for a reduction of said reference signals to be sent. The setting circuitry 32 sets a transmission scheme of at least one reference signal representative of radio conditions in at least one portion of said physical channel based on said configuration and said instruction. The transmitting circuitry 33 transmits, in said physical channel, said at least one reference signal representative of radio conditions in said at least one portion of said physical channel according to said transmission scheme. FIG. 6 is a schematic diagram of a procedure according to example embodiments. The apparatus according to FIG. 3 may perform the method of FIG. 6 but is not limited to this method. The method of FIG. 6 may be performed by the apparatus of FIG. 3 but is not limited to being performed by this apparatus.

As shown in FIG. 6, a procedure according to example embodiments comprises an operation of receiving (S61) a configuration of a number of reference signals to be sent, the reference signals corresponding to a plurality of reference signals representative of radio conditions in a total of a physical channel based on said configuration, an operation of receiving (S62) an instruction for a reduction of said reference signals to be sent, an operation of setting (S63) a transmission scheme of at least one reference signal representative of radio conditions in at least one portion of said physical channel based on said configuration and said instruction, and an operation of transmitting (S64), in said physical channel, said at least one reference signal representative of radio conditions in said at least one portion of said physical channel according to said transmission scheme.

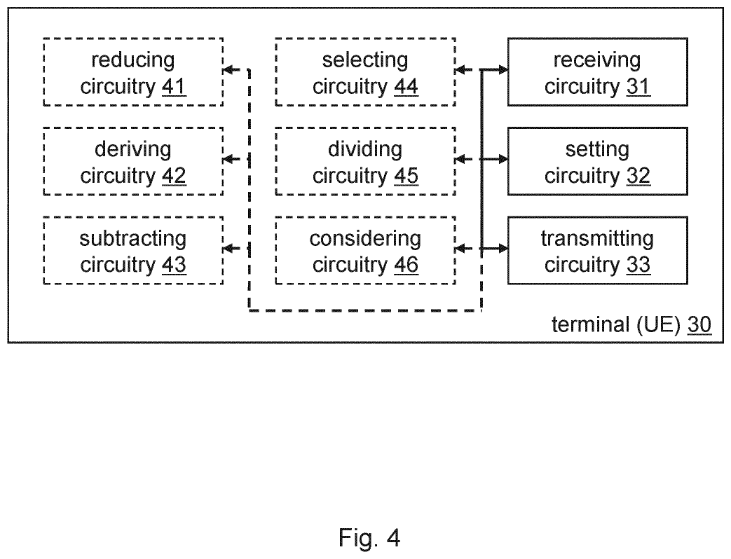

FIG. 4 is a block diagram illustrating an apparatus according to example embodiments. In particular, FIG. 4 illustrates a variation of the apparatus shown in FIG. 3. The apparatus according to FIG. 4 may thus further comprise a reducing circuitry 41, a deriving circuitry 42, a subtracting circuitry 43, a selecting circuitry 44, a dividing circuitry 45, and/or a considering circuitry 46.

In an embodiment at least some of the functionalities of the apparatus shown in FIG. 3 (or 4) may be shared between two physically separate devices forming one operational entity. Therefore, the apparatus may be seen to depict the operational entity comprising one or more physically separate devices for executing at least some of the described processes.

According to a variation of the procedure shown in FIG. 6, said plurality of reference signals is arranged in a time domain, said instruction includes a value as a reduction parameter based on which said number of reference signals to be sent is to be reduced, and exemplary details of the setting operation (S63) are given, which are inherently independent from each other as such. Such exemplary setting operation (S63) according to example embodiments may comprise an operation of reducing said number of reference signals to be sent based on said reduction parameter, and an operation of deriving said at least one reference signal based on a result of said reducing.

According to a variation of the procedure shown in FIG. 6, said reduction parameter is a subtrahend to be subtracted from said number of reference signals to be sent, and exemplary details of the reducing operation are given, which are inherently independent from each other as such. Such exemplary reducing operation according to example embodiments may comprise an operation of subtracting said value from said number of reference signals to be sent.

According to further example embodiments, said number of reference signals to be sent relates to one slot. Alternatively, according to further example embodiments, said number of reference signals to be sent relates to a predetermined number of slots.

According to further example embodiments, said predetermined number of slots include a plurality of consecutive slots. Alternatively, according to further example embodiments, said predetermined number of slots include a plurality of non-consecutive slots.

According to a variation of the procedure shown in FIG. 6, a plurality of reference signal resources corresponding to said plurality of reference signals is arranged in a frequency domain, said instruction includes at least one value as at least one reduction parameter based on which said number of reference signals to be sent is to be reduced, and exemplary details of the setting operation (S63) are given, which are inherently independent from each other as such. Such exemplary setting operation (S63) according to example embodiments may comprise an operation of selecting one of said at least one value as a selected reduction parameter, an operation of reducing said number of reference signals to be sent based on said selected reduction parameter, and an operation of deriving said at least one reference signal based on a result of said reducing.

According to a variation of the procedure shown in FIG. 6, said at least one reduction parameter is at least one reduction divisor by which said number of reference signals to be sent is to be divided, and exemplary details of the reducing operation are given, which are inherently independent from each other as such. Such exemplary reducing operation according to example embodiments may comprise an operation of dividing said number of reference signals to be sent by said selected reduction parameter.

According to a variation of the procedure shown in FIG. 6, exemplary details of the setting operation (S63) are given, which are inherently independent from each other as such. Such exemplary setting operation (S63) according to example embodiments may comprise an operation of considering at least one of a cell load, a transmission scheduler, and a tradeoff between overhead reduction and channel variation sensitivity.

According to further example embodiments, said number of reference signals to be sent relates to one physical resource block. Alternatively, according to further example embodiments, said number of reference signals to be sent relates to a predetermined number of physical resource blocks.

According to further example embodiments, said plurality of reference signals is arranged in a time domain, and said instruction includes a first value as a first reduction parameter based on which said number of reference signals to be sent in said time domain is to be reduced, and of at least one of said plurality of reference signals, a plurality of reference signal resources corresponding to respective components of said respective reference signal is arranged in a frequency domain, and said instruction includes at least one second value as at least one second reduction parameter based on which said number of reference signal components to be sent on said plurality of reference signal resources in said frequency domain is to be reduced.

According to a variation of the procedure shown in FIG. 6, exemplary additional operations are given, which are inherently independent from each other as such. According to such variation, an exemplary method according to example embodiments may comprise an operation of receiving, an return instruction to return to said number of reference signals to be sent, and an operation of setting said transmission scheme of said plurality of reference signals representative of radio conditions in said total of said physical channel based on said return instruction.

Example embodiments outlined and specified above are explained below in more specific terms.

In UL PUSCH transmission, the gNB considers the available UL DMRS pilots to estimate raw channel estimates. After channel estimation, smoothing is applied in frequency domain, and then, interpolation of the smoothed channel estimates is applied.

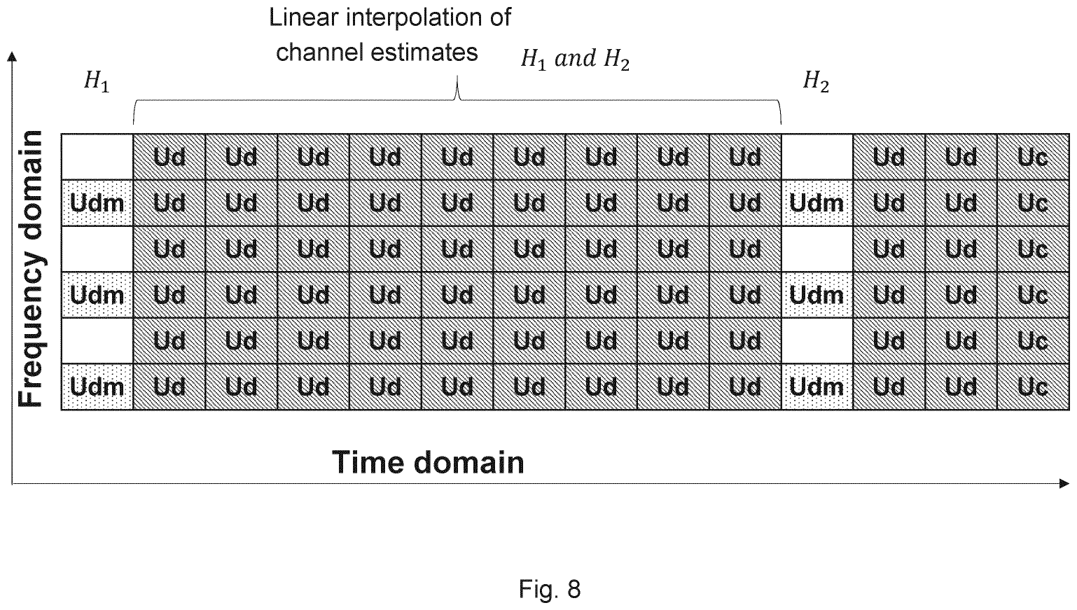

FIG. 8 shows a schematic diagram illustrating channel estimation interpolation according to example embodiments, and in particular illustrates linear interpolation channel estimates with two UL DMRS pilots on one DMRS port.

In FIG. 8, Uc indicates resources for the physical uplink control channel (PUCCH), Ud indicates resources for PUSCH data and phase tracking reference signal (PTRS) (no DMRS), and Udm indicates DMRS associated with PUSCH.

In case of two DMRS pilots, linear interpolation is the most known approach to determine the channel estimates to be fed to the equalizer. The linear interpolation requires at least two channel estimates from UL DMRS pilots, as illustrated in FIG. 8.

For the example summarized in FIG. 8, the channel estimates at symbol I can be interpolated as in Equation 1 (“Linear interpolation for channel estimates”)

$${H}_{l} = \frac{{H}_{2} - {H}_{1}}{{l}_{2} - {l}_{1}} ( l - {l}_{1} ) + {H}_{1} \qquad ( Equation 1 )$$

where
l₁, l₂ are the symbol number of UL DMRS pilot 1 and UL DMRS pilot 2, respectively,
H₁, H₂ are the channel estimates (after smoothing) based on the UL DMRS pilot 1 and the UL DMRS pilot 2, respectively, and
l is the index of orthogonal frequency division multiplexing (OFDM) symbol of PUSCH data.

From the Equation 1 above in Equation, the slope

$$a = \frac{{H}_{2} - {H}_{1}}{{l}_{2} - {l}_{1}}$$

requires to have two UL DMRS pilots.

This example will be used subsequently for the more specific description of example embodiments for clarity and simplicity purpose. However, it is noted that this example is not to be considered as limiting. Namely, neither is the interpolation limited to linear interpolation, nor is the processing limited to two DMRS pilots. In particular, example embodiments consider the UL transmission whatever the number of DMRS is configured and it is not limited to two DMRS pilots.

According to example embodiments, a predictor function is considered to be used for channel realization prediction, whereby the optimal DMRS pattern is inferred. According to example embodiments, such predictor function is implemented by a recurrent neural network (RNN). Such RNN is learned online from UL PUSCH transmissions with legacy DMRS patterns configured by RRC, e.g. based on 3GPP Release 15/16 specifications. Then the RNN is used to predict a model for the channel estimates requiring a minimum number of UL DMRS resources.

### Time Domain DMRS Pattern

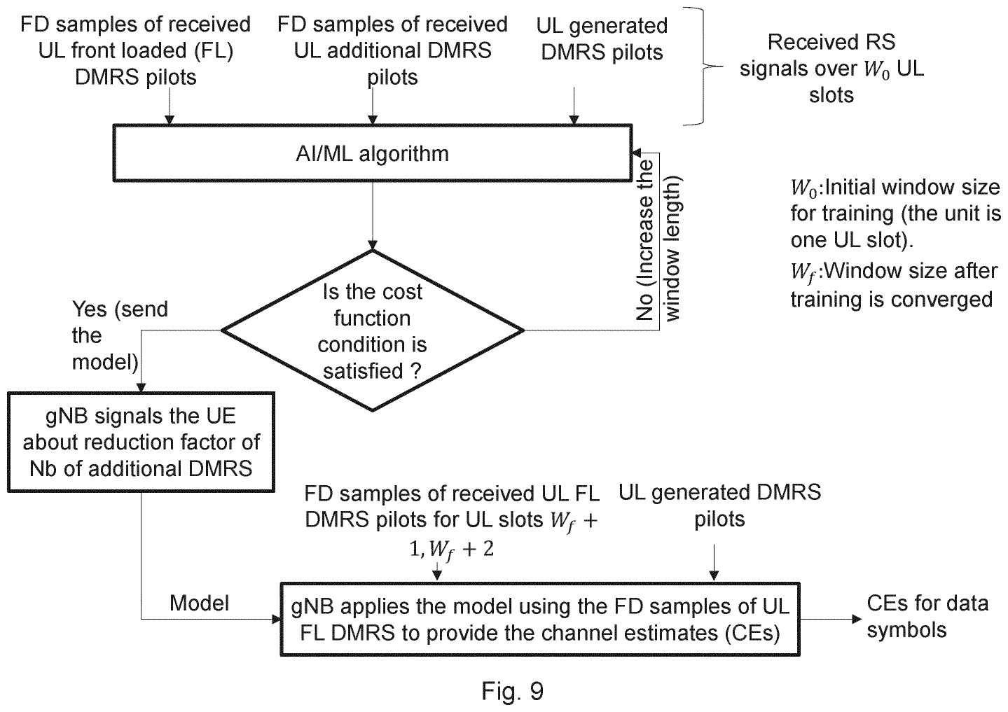

FIG. 9 is a schematic diagram of a procedure according to example embodiments, and in particular illustrates a flow chart of a time domain DMRS pattern update.

As is illustrated in FIG. 9, in a first step of the procedure, an initialization is performed.

In particular, weights of the RNN are initialized. Albeit any initialization would work, according to example embodiments, the values are initialized following a predetermined set of values that could be standard-set. Alternatively, weights developed by assuming a non-changing channel model (such as Rayleigh) can be adopted.

In a second step of FIG. 9, a cost function is defined.

A cost function is needed to train online a RNN. Such function has the role of evaluating the RNN predictions. According to example embodiments, the minimum square error (MSE) of channel estimates from UL DMRS with respect to channel estimates from RNN is considered.

In a third step of FIG. 9, data is fed.

In particular, the received frequency domain samples of UL DMRS pilots are fed to the RNN in order to train online the model. Assuming the example above, the RNN should be trained to provide the slope of a linear interpolation model. Such data will be used for all the function of training, testing and validation, in proportion variable on the different implementations. The RNN will be considered trained when the output will respect a certain quality measure (e.g., MSE below a threshold during a window of time).

In a fourth step of FIG. 9, the RNN model is exploited.

When the RNN model is trained (e.g. the MSE is below the defined threshold), the RNN model is used to predict the channel. According to example embodiments, assuming the example above, the RNN can be set to provide the slope estimate a. According to further example embodiments, a higher order curve fitting scheme is applied, and channel prediction performance is accordingly enhanced, at the expense of higher complexity.

In a fifth step of FIG. 9, the UE is informed.

Namely, from the fourth step, the RNN model is available at the gNB, allowing the L1 baseband to estimate the raw channel estimates from a first front loaded DMRS without any additional DMRS. In the example above, using the slope estimate a available from RNN and the channel estimates from 1 the firstst front loaded DMRS, the gNB can predict the channel estimates for all OFDM symbols without the need of any additional DMRS. Thus, additional DMRS do not provide any benefit in this case and can be dropped to reduce the UL overhead and allows more REs for data symbols.

To inform the UE about to drop the additional DMRS, according to example embodiments, the gNB dynamically signals to the UE via downlink control information (DCI) a new UL DMRS pattern in time domain allocation which consists of only one front loaded DMRS. Alternatively, static signaling using RRC configuration can be applied in case of a static scenario, where the UE speed is low and the quasi-static channel can be assumed over time. However, in contrast to the static signaling, the dynamic signaling of DCI fully benefits from the advantages.

To perform this fifth step with dynamic signaling, according to example embodiments, a (new) field in the DCI is provided and utilized to indicate the reduction factor of UL DMRS pilots.

According to example embodiments, the UE interprets the signaling as follows.

Namely, according to example embodiments, the front loaded DMRS pilots are not concerned by the reduction factor signaled by gNB. Further, according to example embodiments, the information element (IE) supported values are −3, −2, −1, and 0, as maximum four UL DMRS pilots (including the first front loaded DMRS) are supported in 3GPP Release 15, 16. If 0 is signaled to the UE, the legacy DMRS pattern provided by RRC is applied. If −3, −2 or −1 are signaled to the UE, the number of additional DMRS to be sent by UE is equal to legacy additional DMRS number −3, −2 or −1, respectively.

Example embodiments are however not limited to the above-described subtraction based on the value signaled to the UE.

In a sixth step of FIG. 9, performance is monitored.

In particular, according to example embodiments, the gNB monitors a performance value in order to check whether the prediction is sufficiently precise. According to example embodiments, the performance value is the initial block error rate (iBLER). When the iBLER starts to deviate from a defined UL iBLER target (commonly, for example, 10% is used as the iBLER target), the gNB fallbacks to a legacy configuration and signals to the UE, using the signaling procedure explained with respect to the fifth step of FIG. 9, to re-apply the default RRC configuration. In such case, according to example embodiments, the RNN model is retrained online again, whereafter is continued from the third step of FIG. 9.

### Grid of Frequency Domain DMRS Pattern

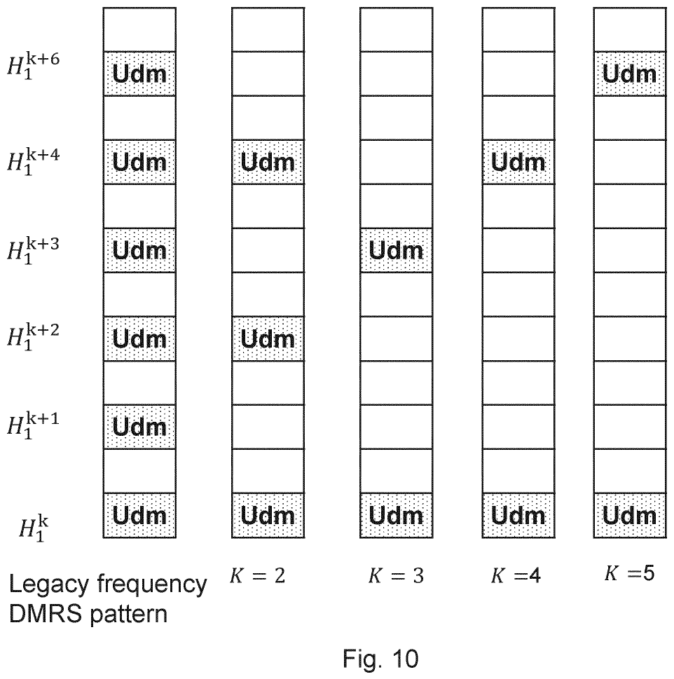

FIG. 10 shows a schematic diagram illustrating DMRS pattern options in the frequency domain according to example embodiments, and in particular illustrates example DMRS patterns derived from a DMRS pattern of type 1 with one DMRS port using a reduction factor of K.

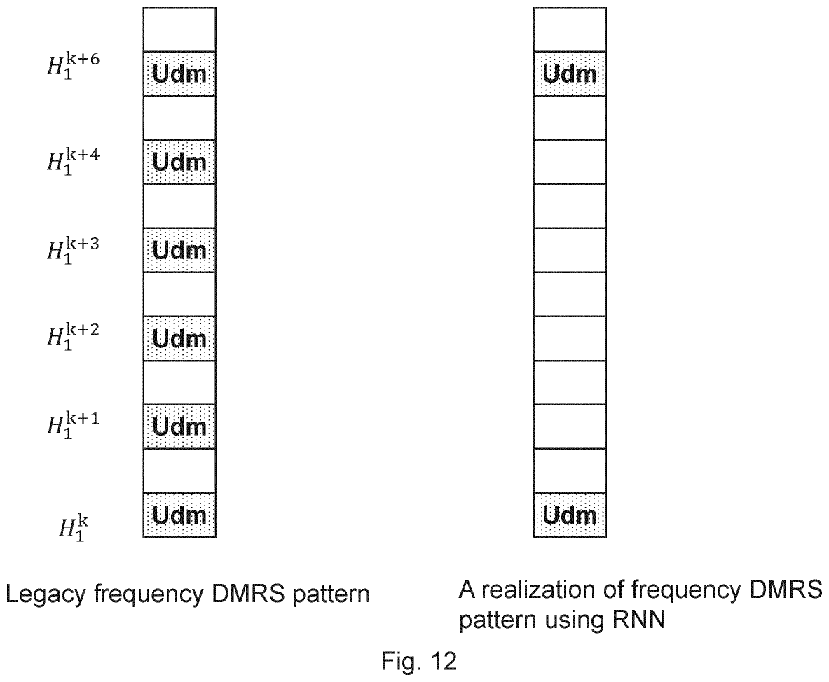

According to example embodiments, in the frequency domain, the RNN model provides in a similar manner the interpolation model to be used. The legacy frequency domain DMRS pattern are defined in TS 38.211, Table 6.4.1.1.3-1 and Table 6.4.1.1.3-2 for PUSCH DMRS configuration type 1 and 2. FIG. 10 (left side) and FIG. 12 (left side) show the frequency DMRS pattern of type 1 with one DMRS port.

To have a more refined frequency domain DMRS pattern, a grid of frequency domain DMRS pattern can be created. These patterns should include at least all frequency domain pattern supported in 3GPP Release 15 and 16. According to example embodiments, these frequency domain DMRS patterns are derived from legacy DMRS pattern by reducing the DMRS frequency density by a reduction factor of K. This is equivalent to application of a dynamic puncturing pattern on top of a 3GPP Release 15 or 16 DMRS pattern. Accordingly, more DMRS patterns are generated from legacy patterns with low specification impact. An example of derived DMRS patterns derived from legacy DMRS pattern for type 1 with one DMRS port are summarized in FIG. 10. The derived DMRS patterns are obtained using a reduction factor of K, where K∈{1, . . . , 11}, as the reduction is applied physical resource block (PRB) wise. For K=1, the legacy DMRS pattern is used.

Example embodiments are however not limited to the above-described multiplication based on the reduction factor of K.

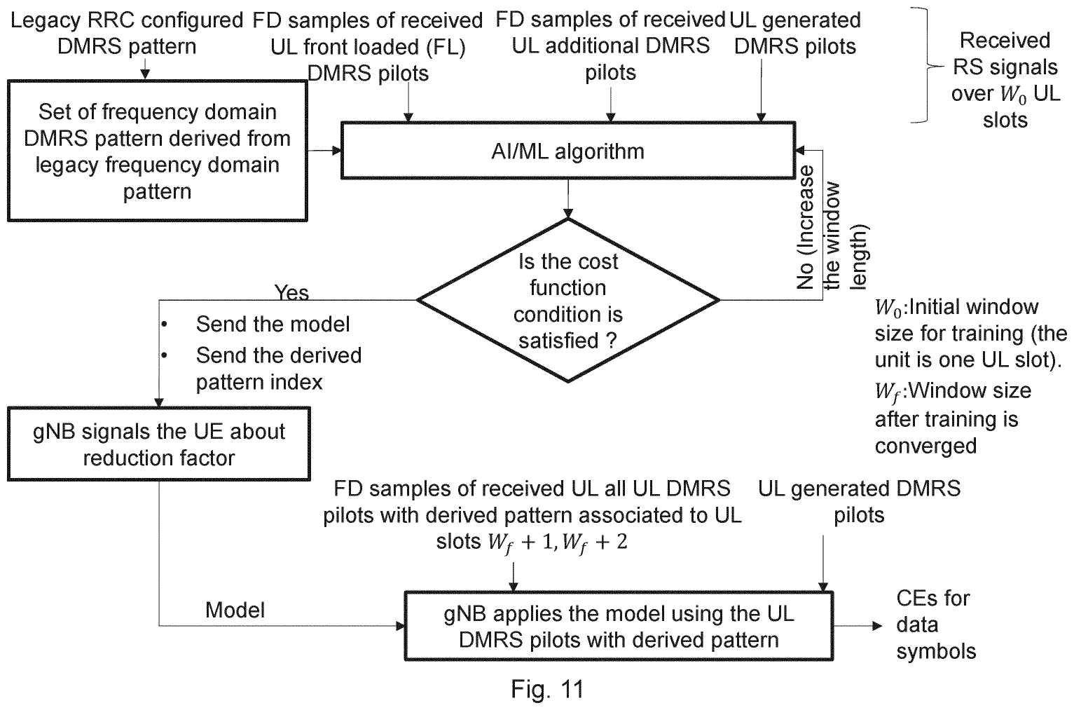

FIG. 11 is a schematic diagram of a procedure according to example embodiments, and in particular illustrates a flow chart of a frequency domain DMRS pattern update.

According thereto, according to example embodiments, the RNN considers the legacy frequency domain pattern (configured by RRC) as a starting pattern. In the training phase, according to example embodiments, the RNN considers as input
all derived DMRS pattern associated to legacy pattern configured in RRC, and
the received samples of UL DMRS pilots.

After training, according to example embodiments, the RNN provides
the reduction factor sub-set {K₁, . . . , K_{L}} of dimension L, from the set {1, . . . , 11}, satisfying the following condition of cost function

$$E ( ‖ {H}_{predicted} - {H}_{estimated} ‖ ) < {Thr}_{cost}$$

the interpolation model Mⱼ associated to each derived DMRS pattern with the reduction factor Kⱼ.

The gNB then can apply depending on the cell load and the UL scheduler which reduction factor is to be applied from the sub-set {K₁, . . . , K_{L}}. A higher reduction factor can lead to a better UL overhead reduction, but is more sensitive for channel variation. On the other hand, a lower reduction factor is more robust for a frequency selective channel, but achieves less UL overhead reduction.

Assuming that the channel estimates is not varying over N REs, one DMRS RE is needed for DMRS, and the other N−1 DMRS REs can be dropped and used for data.

FIG. 12 shows a schematic diagram illustrating a comparison of de-modulation reference signal pattern selections in the frequency domain according to example embodiments, and in particular illustrates an example of a frequency DMRS pattern (selection) according to example embodiments compared to a legacy DMRS pattern.

The RNN is trained to provide the interpolation model for the frequency domain allocation. For the example in FIG. 12, it is assumed that the channel variation between subcarrier k and subcarrier k+5 can be interpolated.

The RNN model according to example embodiments can provide
in this example, the reduction factor of K=5, and
the interpolation model that can be applied.

For the next UL transmission, the gNB uses the interpolated model plus the available UL DMRS REs to provide the channel estimates.

The gNB dynamically signals the UE the reduction factor associated to the derived UL DMRS frequency pattern via DCI. To achieve this signaling, according to example embodiments, a (new) IE field is added/provided/utilized in the DCI to indicate the reduction factor.

The example embodiments have been described above for ease of understanding of the present disclosure.

However, the present disclosure and the concept behind the present disclosure is not limited to the example embodiments outlined, specified and explained above.

According to further example embodiments, in particular the gNB may be modified as follows.

In particular, according to further example embodiments, the derived DMRS patterns are considered over a bundle of b PRBs, where b>1. Thus, the set of derived reduction factor is extended to {1, . . . , 12*b−1}.

Further, according to further example embodiments, the selection of DMRS patterns in frequency domain and time domain are done jointly.

Still further, according to further example embodiments, another machine learning algorithms other than the RNN is considered.

Still further, according to further example embodiments, the time domain DMRS pattern is used over a bundle of UL slots, where joint UL channel estimation can be applied. Thus, the reduction of additional DMRS can be applied to repetition UL slots and/or the first transmission. The range of reduction factor in time domain can be extended for [−3:3] to [−3*N:3*N], where N is the number of UL slots used for joint channel estimation.

Still further, according to further example embodiments, for DL DMRS transmission, the UE implements the functionality outlined, specified and explained above in relation to the gNB. For this case, the UE needs to report to gNB its suggested DL DMRS pattern (in time and frequency) as well as its curve fitting order (in the fourth step of FIG. 9), and thus assists the gNB scheduler to determine the tradeoff between signaling overhead and learning complexity, and therefore the final DL DMRS transmission.

According to further example embodiments, the gNB can exploit UL-DL reciprocity to implement the above explained functionality to predict and adapt the DL DMRS transmission.

According to example embodiments, advantageously, the current specification can be extended with low effort.

Further, according to example embodiments, advantageously, a flexible approach is provided, as it can track channel time variation (for example, UE speed change, etc.).

Further, according to example embodiments, advantageously, a low impact to UE implementation is required. The UE can use the legacy method to generate the DMRS, and then a puncturing operation can be proceeded to generate the derived DMRS patterns.

Further, according to example embodiments, advantageously, interoperability is ensured, as it can work for legacy UE as it incorporates the DMRS patterns specified in 3GPP Release 15.

Finally, according to example embodiments, advantageously, scalability is ensured, as it extends the number of DMRS pattern to a high number of DMRS pattern by puncturing the 3GPP Release 15 patterns, such that low signaling is required.

The above-described procedures and functions may be implemented by respective functional elements, processors, or the like, as described below.

In the foregoing exemplary description of the network entity, only the units that are relevant for understanding the principles of the disclosure have been described using functional blocks. The network entity may comprise further units that are necessary for its respective operation. However, a description of these units is omitted in this specification. The arrangement of the functional blocks of the devices is not construed to limit the disclosure, and the functions may be performed by one block or further split into sub-blocks.

When in the foregoing description it is stated that the apparatus, i.e. network entity (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “unit configured to” is construed to be equivalent to an expression such as “means for”).

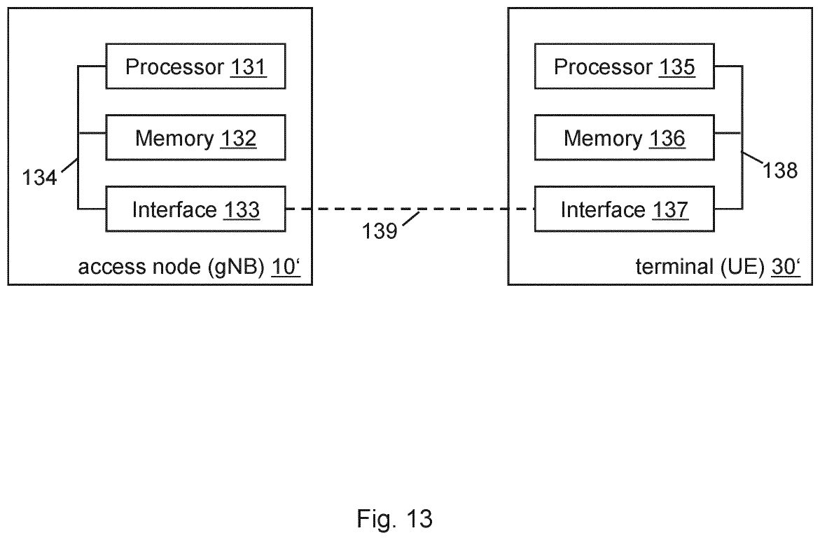

In FIG. 13, an alternative illustration of apparatuses according to example embodiments is depicted. As indicated in FIG. 13, according to example embodiments, the apparatus (access node) 10′ (corresponding to the access node 10) comprises a processor 131, a memory 132 and an interface 133, which are connected by a bus 134 or the like. Further, according to example embodiments, the apparatus (terminal) 30′ (corresponding to the terminal 30) comprises a processor 135, a memory 136 and an interface 137, which are connected by a bus 138 or the like, and the apparatuses may be connected via link 139, respectively.

The processor 131/135 and/or the interface 133/137 may also include a modem or the like to facilitate communication over a (hardwire or wireless) link, respectively. The interface 133/137 may include a suitable transceiver coupled to one or more antennas or communication means for (hardwire or wireless) communications with the linked or connected device(s), respectively. The interface 133/137 is generally configured to communicate with at least one other apparatus, i.e. the interface thereof.

The memory 132/136 may store respective programs assumed to include program instructions or computer program code that, when executed by the respective processor, enables the respective electronic device or apparatus to operate in accordance with the example embodiments.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that at least one processor, potentially in cooperation with computer program code stored in the memory of the respective apparatus, is configured to cause the apparatus to perform at least the thus mentioned function. Also, such function is to be construed to be equivalently implementable by specifically configured means for performing the respective function (i.e. the expression “processor configured to [cause the apparatus to] perform xxx-ing” is construed to be equivalent to an expression such as “means for xxx-ing”).

According to example embodiments, an apparatus representing the network node or entity (i.e., access node) 10 comprises at least one processor 131, at least one memory 132 including computer program code, and at least one interface 133 configured for communication with at least another apparatus. The processor (i.e. the at least one processor 131, with the at least one memory 132 and the computer program code) is configured to perform receiving, from a communication entity, in a physical channel, at least one reference signal representative of radio conditions in at least one portion of said physical channel (thus the apparatus comprising corresponding means for receiving), and to perform predicting, based on said at least one reference signal and a model of said physical channel, a first channel estimation representative of radio conditions in a total of said physical channel (thus the apparatus comprising corresponding means for predicting).

According to example embodiments, an apparatus representing the network node or entity (i.e., terminal) 30 comprises at least one processor 135, at least one memory 136 including computer program code, and at least one interface 137 configured for communication with at least another apparatus. The processor (i.e. the at least one processor 135, with the at least one memory 136 and the computer program code) is configured to perform receiving a configuration of a number of reference signals to be sent, the reference signals corresponding to a plurality of reference signals representative of radio conditions in a total of a physical channel based on said configuration (thus the apparatus comprising corresponding means for receiving), to perform receiving an instruction for a reduction of said reference signals to be sent, to perform setting a transmission scheme of at least one reference signal representative of radio conditions in at least one portion of said physical channel based on said configuration and said instruction (thus the apparatus comprising corresponding means for setting), and to perform transmitting, in said physical channel, said at least one reference signal representative of radio conditions in said at least one portion of said physical channel according to said transmission scheme (thus the apparatus comprising corresponding means for transmitting).

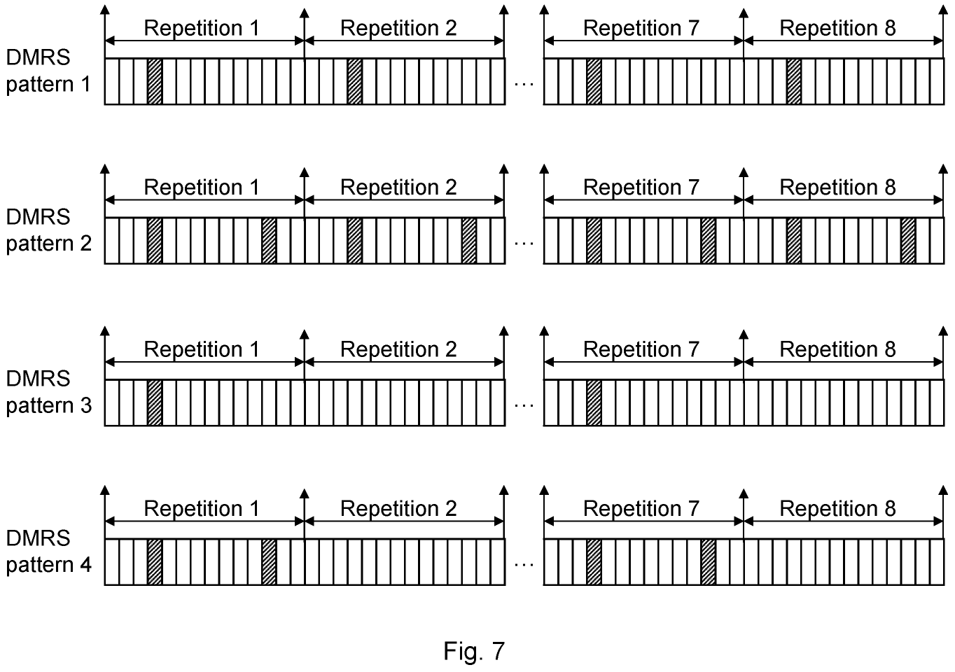

For further details regarding the operability/functionality of the individual apparatuses, reference is made to the above description in connection with any one of FIGS. 1 to 12, respectively.

For the purpose of the present disclosure as described herein above, it should be noted that
method steps likely to be implemented as software code portions and being run using a processor at a network server or network entity (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined network entity or network register, or any one of their respective units/means) can be implemented as individual devices, units or means, but this does not exclude that they are implemented in a distributed fashion throughout the system, as long as the functionality of the device, unit or means is preserved;
an apparatus like the user equipment and the network entity/network register may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present disclosure. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present disclosure also covers any conceivable combination of method steps and operations described above, and any conceivable combination of nodes, apparatuses, modules or elements described above, as long as the above-described concepts of methodology and structural arrangement are applicable.

In view of the above, there are provided measures for adaptive de-modulation reference signal pattern design. Such measures exemplarily comprise receiving, from a communication entity, in a physical channel, at least one reference signal representative of radio conditions in at least one portion of said physical channel, and predicting, based on said at least one reference signal and a model of said physical channel, a first channel estimation representative of radio conditions in a total of said physical channel.

Even though the disclosure is described above with reference to the examples according to the accompanying drawings, it is to be understood that the disclosure is not restricted thereto. Rather, it is apparent to those skilled in the art that the present disclosure can be modified in many ways without departing from the scope of the inventive idea as disclosed herein.

### LIST OF ACRONYMS AND ABBREVIATIONS

3GPP Third Generation Partnership Project
DCI downlink control information
DMRS de-modulation reference signal
iBLER initial block error rate
IE information element
MSE minimum square error
OFDM orthogonal frequency division multiplexing
PRB physical resource block
PTRS phase tracking reference signal
PUCCH physical uplink control channel
PUSCH physical uplink shared channel
RE resource element
RNN recursive/recurrent neural network
RRC radio resource control
UE user equipment
UL uplink

1-83. (canceled)

84. An apparatus, comprising:
at least one processor; and
at least one memory including computer program code;
the at least one memory and the computer program code configured to, with the at least one processor, cause the apparatus at least to:
receive a configuration of a number of reference signals to be sent, the reference signals corresponding to a plurality of reference signals representative of radio conditions in a total of a physical channel based on said configuration;
receive an instruction for a reduction of said reference signals to be sent;
set a transmission scheme of at least one reference signal representative of radio conditions in at least one portion of said physical channel based on said configuration and said instruction, and
transmit, in said physical channel, said at least one reference signal representative of radio conditions in said at least one portion of said physical channel according to said transmission scheme.

85. The apparatus of claim 84, wherein
said plurality of reference signals is arranged in a time domain,
said instruction includes a value as a reduction parameter based on which said number of reference signals to be sent is to be reduced, and
in relation to said setting, the apparatus is further caused to:
reduce said number of reference signals to be sent based on said reduction parameter, and
derive said at least one reference signal based on a result of said reducing.

86. The apparatus according to claim 85, wherein
said reduction parameter is a subtrahend to be subtracted from said number of reference signals to be sent, and
in relation to said reducing, the apparatus is further caused to:
subtract said value from said number of reference signals to be sent.

87. The apparatus according to claim 84, wherein
said number of reference signals to be sent relates to one slot, or wherein
said number of reference signals to be sent relates to a predetermined number of slots.

88. The apparatus according to claim 87, wherein
said predetermined number of slots include a plurality of consecutive slots, or wherein
said predetermined number of slots include a plurality of non-consecutive slots.

89. The apparatus according to claim 84, wherein
a plurality of reference signal resources corresponding to said plurality of reference signals is arranged in a frequency domain,
said instruction includes at least one value as at least one reduction parameter based on which said number of reference signals to be sent is to be reduced, and
in relation to said setting, the apparatus is further caused to:
select one of said at least one value as a selected reduction parameter,
reduce said number of reference signals to be sent based on said selected reduction parameter, and
derive said at least one reference signal based on a result of said reducing.

90. The apparatus according to claim 89, wherein
said at least one reduction parameter is at least one reduction divisor by which said number of reference signals to be sent is to be divided, and
in relation to said reducing, the apparatus is further caused to:
divide said number of reference signals to be sent by said selected reduction parameter.

91. The apparatus according to claim 89, wherein
in relation to said setting, the apparatus is further caused to:
consider at least one of a cell load, a transmission scheduler, and a tradeoff between overhead reduction and channel variation sensitivity.

92. The apparatus according to claim 89, wherein
said number of reference signals to be sent relates to one physical resource block, or wherein
said number of reference signals to be sent relates to a predetermined number of physical resource blocks.

93. The apparatus according to claim 84, wherein
said plurality of reference signals is arranged in a time domain, and said instruction includes a first value as a first reduction parameter based on which said number of reference signals to be sent in said time domain is to be reduced, and
of at least one of said plurality of reference signals, a plurality of reference signal resources corresponding to respective components of said respective reference signal is arranged in a frequency domain, and said instruction includes at least one second value as at least one second reduction parameter based on which said number of reference signal components to be sent on said plurality of reference signal resources in said frequency domain is to be reduced.

94. The apparatus according to claim 84, wherein the apparatus is further caused to:
receive, a return instruction to return to said number of reference signals to be sent, and
set said transmission scheme of said plurality of reference signals representative of radio conditions in said total of said physical channel based on said return instruction.

95. An apparatus comprising:
at least one processor; and
at least one memory including computer program code;
the at least one memory and the computer program code configured to, with the at least one processor, cause the apparatus at least to:
receive, from a communication entity, in a physical channel, at least one reference signal representative of radio conditions in at least one portion of said physical channel, and
predict, based on said at least one reference signal and a model of said physical channel, a first channel estimation representative of radio conditions in a total of said physical channel.

96. The apparatus according to claim 95, wherein the apparatus is further caused to:
train said model of said physical channel, and
transmit, in response to completion of said training of said model of said physical channel, towards said communication entity, an instruction for a reduction of reference signals to be sent by said communication entity.

97. The apparatus according to claim 96, wherein in relation to said training, the apparatus is further caused to:
receive a plurality of reference signals representative of radio conditions in said total of said physical channel, including said at least one reference signal,
generate, based on said plurality of reference signals, a second channel estimation representative of radio conditions in said total of said physical channel,
compare said first channel estimation with said second channel estimation, and
modify said model of said physical channel based on a result of said comparing.

98. The apparatus according to claim 96, wherein
said plurality of reference signals is arranged in a time domain, and
said instruction includes a value as a reduction parameter based on which an originally configured number of reference signals to be sent by said communication entity is to be reduced.

99. The apparatus according to claim 98, wherein the apparatus is further caused to:
determine completion of said training of said model of said physical channel, if a deviation between said first channel estimation and said second channel estimation is smaller than a predetermined training threshold.

100. The apparatus according to claim 96, wherein
a plurality of reference signal resources corresponding to said plurality of reference signals is arranged in a frequency domain, and
said instruction includes at least one value as at least one reduction parameter based on which an originally configured number of reference signals to be sent by said communication entity is to be reduced.

101. The apparatus according to claim 100, wherein
said at least one reduction parameter is at least one reduction divisor by which said originally configured number of reference signals to be sent by said communication entity is to be divided.

102. The apparatus according to claim 96, wherein
said plurality of reference signals is arranged in a time domain, and said instruction includes a first value as a first reduction parameter based on which an originally configured number of reference signals to be sent by said communication entity in said time domain is to be reduced, and
of at least one of said plurality of reference signals, a plurality of reference signal resources corresponding to respective components of said respective reference signal is arranged in a frequency domain, and said instruction includes at least one second value as at least one second reduction parameter based on which an originally configured number of reference signal components to be sent by said communication entity on said plurality of reference signal resources in said frequency domain is to be reduced.

103. A method comprising:
receiving a configuration of a number of reference signals to be sent, the reference signals corresponding to a plurality of reference signals representative of radio conditions in a total of a physical channel based on said configuration,
receiving an instruction for a reduction of said reference signals to be sent,
setting a transmission scheme of at least one reference signal representative of radio conditions in at least one portion of said physical channel based on said configuration and said instruction, and
transmitting, in said physical channel, said at least one reference signal representative of radio conditions in said at least one portion of said physical channel according to said transmission scheme.
